(19) United States
(12) Patent Application Publication
(10) Pub. No.: US 2025/0077908 A1
(43) Pub. Date: Mar. 6, 2025

(54) INFORMATION PROCESSING DEVICE, HYPOTHESIS GENERATION METHOD, PROGRAM, AND RECORDING MEDIUM

(71) Applicant: NEC CORPORATION, Minato-ku, Tokyo (JP)

(72) Inventor: Shota MOTOURA, Tokyo (JP)

(73) Assignee: NEC CORPORATION, Minato-ku, Tokyo (JP)

(21) Appl. No.: 18/265,637

(22) PCT Filed: Dec. 16, 2020
(86) PCT No.: PCT/JP2020/046862

§ 371 Date: Jun. 6, 2023

(51) Int. Cl. G06N 5/04; G06N 5/02

(52) U.S. Cl. CPC G06N 5/04; G06N 5/02

(57) ABSTRACT

In order to generate a hypothesis which is convincing to a user, an information processing device (1) includes: a hypothesis generation section (11) which generates, by abductive inference, a plurality of hypotheses that differ from each other; a hypothesis display section (12) which causes a display device to display a plurality of elements making up each of the plurality of hypotheses that have been generated; and an acceptance section (13) which accepts, from a user, a feedback on at least one of the plurality of elements that have been displayed. The hypothesis generation section (11) applies a constraint condition which varies depending on the feedback, and regenerates at least one hypothesis.

### TECHNICAL FIELD

The present invention relates to an information processing device which generates a hypothesis by abductive inference, and the like.

### BACKGROUND ART

Abductive inference is inference that derives, on the basis of a given observation, a hypothesis about an event which has occurred. Research on abductive inference has been conventionally carried out. For example, Non-Patent Literature 1 below suggests a method of automatically adjusting parameters of weighted abductive inference by supervised learning.

### CITATION LIST

### Non-Patent Literature

[Non-patent Literature 1]
Kazeto Yamamoto et. al., “Backpropagation Learning for Weighted Abduction”, IPSJ SIG Technical Report, Vol. 2012-NL-206, No. 9/Vol. 2012-SLP-91, No. 9, 2012

### SUMMARY OF INVENTION

### Technical Problem

The weighted abductive inference disclosed in Non-Patent Literature 1 derives a hypothesis that maximizes an evaluation function. However, evaluation by this evaluation function does not necessarily coincide with an evaluation criterion of a user. Thus, the technique in Non-Patent Literature 1 has a problem that it may be impossible to derive a hypothesis which is convincing to a user.

An example aspect of the present invention has been made in view of the above problem, and an example object thereof is to provide an information processing device and the like, each of which makes it possible to generate a hypothesis which is convincing to a user.

### Solution to Problem

An information processing device according to an example aspect of the present invention includes: a hypothesis generation means for generating, by abductive inference, a plurality of hypotheses that differ from each other; a hypothesis display means for causing a display device to display a plurality of elements making up each of the plurality of hypotheses that have been generated; and an acceptance means for accepting, from a user, a feedback on at least one of the plurality of elements that have been displayed, the hypothesis generation means applying a constraint condition which varies depending on the feedback, and regenerating at least one hypothesis.

A hypothesis generation method according to an example aspect of the present invention includes: (a) generating, by abductive inference, a plurality of hypotheses that differ from each other; (b) causing a display device to display a plurality of elements making up each of the plurality of hypotheses that have been generated; (c) accepting, from a user, a feedback on at least one of the plurality of elements that have been displayed; and (d) applying a constraint condition which varies depending on the feedback, and regenerating at least one hypothesis, the steps (a) through (d) being carried out by at least one processor.

A program according to an example aspect of the present invention causes a computer to function as: a hypothesis generation means for generating, by abductive inference, a plurality of hypotheses that differ from each other; a hypothesis display means for causing a display device to display a plurality of elements making up each of the plurality of hypotheses that have been generated; and an acceptance means for accepting, from a user, a feedback on at least one of the plurality of elements that have been displayed, the hypothesis generation means applying a constraint condition which varies depending on the feedback, and regenerating at least one hypothesis.

A recording medium according to an example aspect of the present invention is a computer-readable recording medium in which a program for causing a computer to function as an information processing device is recorded, the program causing the computer to function as: a hypothesis generation means for generating, by abductive inference, a plurality of hypotheses that differ from each other; a hypothesis display means for causing a display device to display a plurality of elements making up each of the plurality of hypotheses that have been generated; and an acceptance means for accepting, from a user, a feedback on at least one of the plurality of elements that have been displayed, the hypothesis generation means applying a constraint condition which varies depending on the feedback, and regenerating at least one hypothesis.

### Advantageous Effects of Invention

According to an example aspect of the present invention, it is possible to generate a hypothesis which is convincing to a user.

### BRIEF DESCRIPTION OF DRAWINGS

FIG. 1 is a block diagram illustrating a configuration of an information processing device according to a first example embodiment of the present invention.

FIG. 2 is a flowchart illustrating a flow of a hypothesis generation method according to the first example embodiment of the present invention.

FIG. 3 is a block diagram illustrating a configuration of an information processing device according to a second example embodiment of the present invention.

FIG. 4 is a drawing illustrating example hypothesis graphs.

FIG. 5 is a flowchart illustrating a flow of a hypothesis generation method according to the second example embodiment of the present invention.

FIG. 6 is a drawing illustrating an example of a UI screen for accepting a feedback from a user.

FIG. 7 is a drawing illustrating an example of a selection screen for causing a user to select contents of feedbacks.

FIG. 8 is a drawing illustrating an example of a computer which executes instructions of a program that is software for realizing functions of the information processing device.

### EXAMPLE EMBODIMENTS

### First Example Embodiment

The following description will discuss, in detail, a first example embodiment of the present invention with reference to the drawings. The first example embodiment is made the basis of an example embodiment described later.

### (Configuration of Information Processing Device)

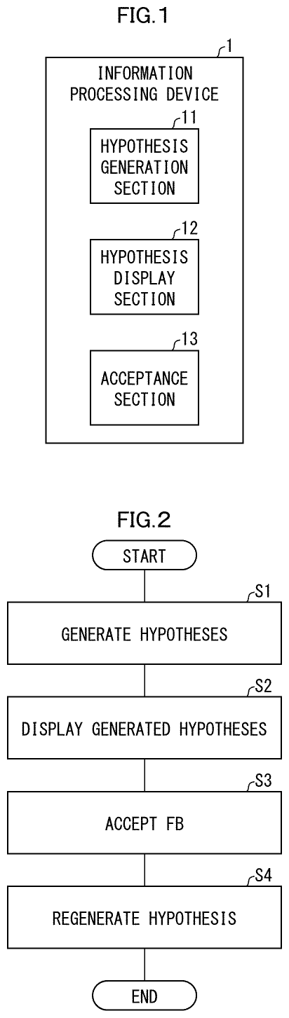

A configuration of an information processing device 1 according to the first example embodiment is described with reference to FIG. 1. FIG. 1 is a block diagram illustrating the configuration of the information processing device 1. The information processing device 1 is a device which generates a hypothesis by abductive inference. As illustrated in FIG. 1, the information processing device 1 includes a hypothesis generation section 11, a hypothesis display section 12, and an acceptance section 13.

The hypothesis generation section 11 generates, by abductive inference, a plurality of hypotheses that differ from each other. More specifically, the hypothesis generation section 11 generates the plurality of hypotheses with use of observation information and inference knowledge. The observation information, the inference knowledge, and the hypotheses are each expressed by a logical formula. As a specific method of carrying out the abductive inference, it is possible to apply various methods, such as weighted abductive inference as disclosed in Non-Patent Literature 1.

Note, here, that hypotheses that differ from each other indicate hypotheses that differ from each other in graphical feature when graphed. For example, a node, a combination of nodes, an edge, a combination of edges, and a combination of one or more nodes and one or more edges can be each a graphical feature. In hypothesis graphs obtained by graphing a respective plurality of hypotheses, it is possible to embed, in parts which are identical to each other in graphical feature, subgraphs which are identical to each other with the exception of a difference in variable name. On the contrary, in parts which differ from each other in graphical feature, it is impossible to embed subgraphs which are identical to each other with the exception of a difference in variable name. It is possible to determine, as desired, what ranges are set as sets of features that the information processing device 1 handles, i.e., what ranges in the hypothesis graphs are set as graphical features.

That it is possible to make an embedding means that there is injective assignment of one or more variables and/or one or more constants. For example, it is possible to embed the following hypothesis H′ into the following hypothesis H. This is because it is possible to assign, in an injective manner, (i) y in the hypothesis H′ to x and (ii) z in the hypothesis H′ to C1.
H: T(x)→P(x)→Q(x, C1),
   S(C, C1)→!R(C1)
H′: P(y)→Q(y, C1),
   !R(z)
      Note that the injective manner means that coincidence does not occur in destination (destination of assignment). Note also that, in each of the above logical formulae, “!” represents negation, upper case letters each represent a constant, and lower case letters each represent a variable.

The hypothesis display section 12 causes a display device to display a plurality of elements making up each of the plurality of hypotheses that have been generated. The hypothesis display section 12 only needs to cause the display device to display the elements, which make up each of the hypotheses, in such a manner that a user can recognize the elements. For example, since the abductive inference is carried out with use of logical formulae as described above, the hypothesis display section 12 may cause the display device to display the logical formulae which express the hypotheses. Alternatively, since it is possible to express the hypotheses by respective hypothesis graphs each of which is made up of a combination of nodes and at least one edge, the hypothesis display section 12 may cause the display device to display the hypothesis graphs. Note that the display device may be included in the information processing device 1 or may be provided outside the information processing device 1.

The acceptance section 13 accepts, from a user, a feedback on at least one of the elements that have been displayed. In a case where the acceptance section 13 accepts the feedback, the hypothesis generation section 11 applies a constraint condition which varies depending on the feedback, and regenerates at least one hypothesis.

The feedback only needs to be on at least one of the elements that have been displayed. For example, the acceptance section 13 may accept a feedback on each of the above-described graphical features. A content of the feedback only needs to make it possible to determine a constraint condition for regenerating at least one hypothesis. For example, the acceptance section 13 may accept a feedback which is on a part of logical formulae that make up a hypothesis and which indicates that the part is appropriate or inappropriate.

How to accept the feedback is also not limited in particular. For example, the acceptance section 13 may accept, as the feedback, an input operation that a user has conducted via any input device such as a mouse or a touch panel.

As has been described above, the information processing device 1 according to the first example embodiment includes: the hypothesis generation section 11 which generates, by abductive inference, a plurality of hypotheses that differ from each other; the hypothesis display section 12 which causes a display device to display a plurality of elements making up each of the plurality of hypotheses that have been generated; and the acceptance section 13 which accepts, from a user, a feedback on at least one of the plurality of elements that have been displayed. Then, a configuration is employed such that the hypothesis generation section 11 (i) applies a constraint condition that varies depending the feedback and (ii) regenerates at least one hypothesis.

According to the above configuration, the display device is caused to display the plurality of elements making up each of the plurality of hypotheses. It is therefore possible for the user of the information processing device 1 to (i) determine whether each of the elements, which make up each of the hypotheses, is appropriate or not and (ii) feed a result of the determination back. Generally, since user's knowledge is limited, it may be difficult to cause a user to determine whether an entire hypothesis is appropriate. However, even in such a case, it is often possible for the user to determine whether a part of elements which make up the hypothesis is appropriate or not, within a range of the user's knowledge. Moreover, providing such a feedback is easy even for a user who does not have detailed knowledge about logical formulae and the like.

According to the above configuration, the constraint condition which varies depending on such a feedback is applied, and at least one hypothesis is regenerated. Since this regeneration of at least one hypothesis is carried out on the basis of the constraint condition which varies depending on the feedback from the user, the at least one hypothesis thus regenerated is likely to be more convincing to the user than the hypotheses previously generated. Therefore, the information processing device 1 according to the first example embodiment brings about the effect that it is possible to generate a hypothesis which is convincing to a user.

It is possible to suitably apply the information processing device 1 to a case where a user checks a hypothesis and, on the basis of a content of the hypothesis, takes some action on user's responsibility. This is because, in a case where the information processing device 1 is used for such a case, the user does not take an action on the basis of a hypothesis which is not convincing to the user. For example, it is possible to use the information processing device 1 for a case where a hypothesis about cyber-security is generated. In this case, since the information processing device 1 generates a hypothesis which is convincing to a user on the basis of a feedback from the user, it is possible to cause the user to take an action necessary for cyber-security on the basis of the hypothesis.

### (Flow of Hypothesis Generation Method)

A flow of a hypothesis generation method according to the first example embodiment is described with reference to FIG. 2. FIG. 2 is a flowchart illustrating a flow of the hypothesis generation method.

In the hypothesis generation method illustrated in FIG. 2, the hypothesis generation section 11 first generates, by abductive inference, a plurality of hypotheses that differ from each other (S1). Next, the hypothesis display section 12 causes a display device to display a plurality of elements making up each of the plurality of hypotheses that have been generated in S1 (S2).

Subsequently, the acceptance section 13 accepts, from a user, a feedback (FB) on at least one of the elements that have been displayed by the process in S2 (S3). Then, the hypothesis generation section 11 applies a constraint condition which varies depending on the feedback accepted in S3, and regenerates at least one hypothesis (S4). This ends the hypothesis generation method. The hypothesis generation method according to the first example embodiment brings about the effect that it is possible to generate a hypothesis which is convincing to a user.

Note that in a case where the functions of the hypothesis generation section 11, the hypothesis display section 12, and the acceptance section 13 are realized by at least one processor, it can be expressed that the processes in S1 to S4 are carried out by the at least one processor. Note also that, after the process in S4, the process in S2 may be carried out. In this case, in S2, a plurality of hypotheses including the at least one hypothesis that has been newly generated by the regeneration are caused to be displayed. In this manner, by repeatedly carrying out the processes in S2 to S4, it is possible to generate a hypothesis which is more convincing to a user.

### Second Example Embodiment

### (Configuration of Information Processing Device)

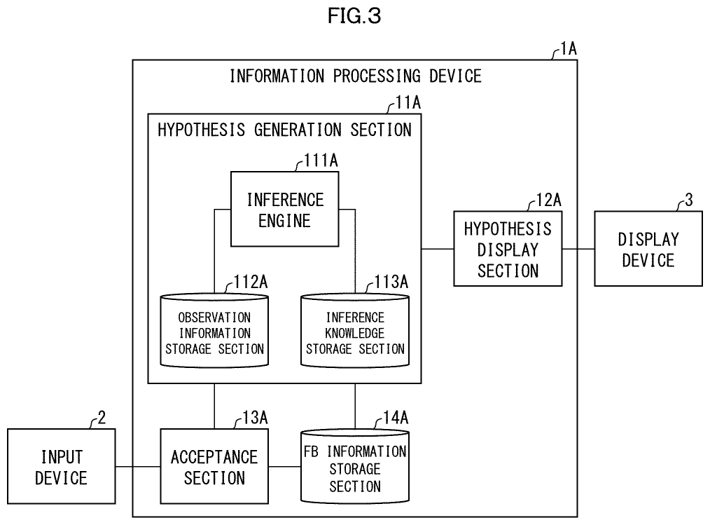

A configuration of an information processing device 1A according to a second example embodiment is described with reference to FIG. 3. FIG. 3 is a block diagram illustrating the configuration of the information processing device 1A. The information processing device 1A is a device which generates a hypothesis by abductive inference, similarly to the information processing device 1 according to the first example embodiment. FIG. 3 also illustrates (i) an input device 2 which accepts an input operation that a user has conducted and which outputs, to the information processing device 1A, information indicating a content of the input operation that the input device 2 has accepted and (ii) a display device 3 which displays information that the information processing device 1A has outputted.

The information processing device 1A includes a hypothesis generation section 11A, a hypothesis display section 12A, an acceptance section 13A, and a feedback (FB) information storage section 14A. The hypothesis generation section 11A includes an inference engine 111A, an observation information storage section 112A, and an inference knowledge storage section 113A.

Similarly to the hypothesis generation section 11 of the first example embodiment, the hypothesis generation section 11A generates, by abductive inference, a plurality of hypotheses that differ from each other, by combining a plurality of elements. The hypothesis generation section 11A also applies a constraint condition which varies depending on a feedback, and regenerates at least one hypothesis.

More specifically, the abductive inference carried out by the hypothesis generation section 11A is carried out by the inference engine 111A. Specifically, the inference engine 111A carries out the abductive inference with use of observation information stored in the observation information storage section 112A and inference knowledge stored in the inference knowledge storage section 113A. The observation information is information indicating an evidence or the like concerning an event which is a target of the abductive inference. The inference knowledge is knowledge obtained by accumulating various pieces of information which can be used for the abductive inference. The inference knowledge may include, for example, information indicating a fact. The inference knowledge is also referred to as background knowledge.

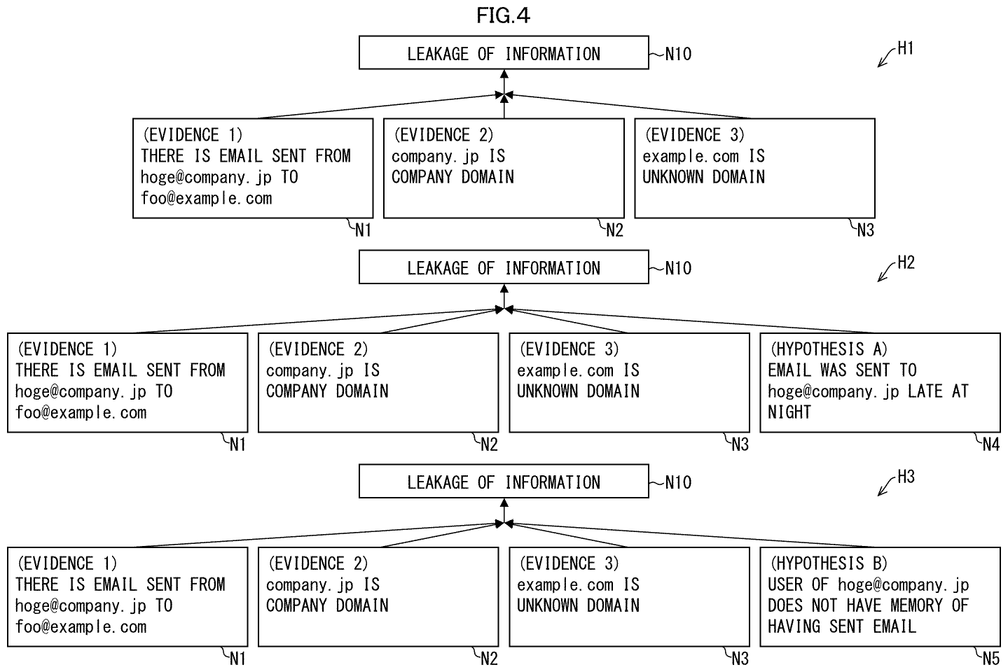

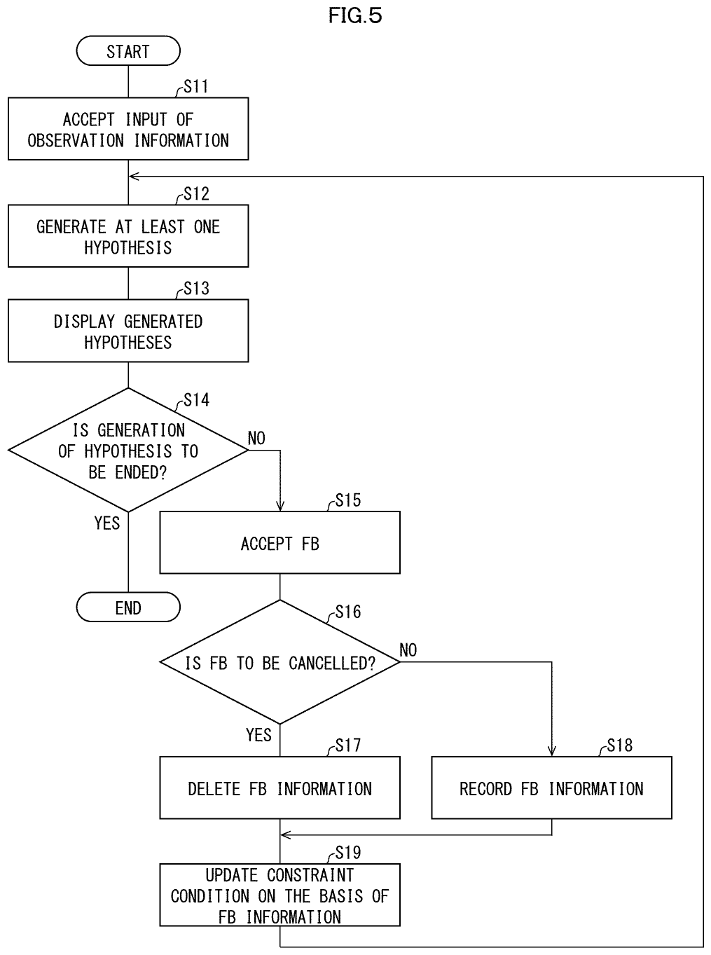

Similarly to the hypothesis display section 12 of the first example embodiment, the hypothesis display section 12A causes a display device to display the elements making up each of the plurality of hypotheses that have been generated. More specifically, the hypothesis display section 12A causes the display device to display hypothesis graphs in each of which the plurality of elements and a combination thereof are expressed with use of nodes and at least one edge. The hypothesis graphs will be described later with reference to FIG. 4.

Similarly to the acceptance section 13 of the first example embodiment, the acceptance section 13A accepts, from a user, a feedback on at least one of the elements that have been displayed. The acceptance section 13A also generates feedback information indicating a content of the feedback which the acceptance section 13A has accepted, and records the feedback information in the FB information storage section 14A. A process of generating and recording feedback information is carried out with respect to each feedback. Namely, pieces of feedback information indicating respective contents of feedbacks that the acceptance section 13A has accepted are accumulated in the FB information storage section 14A. The hypothesis generation section 11A regenerates at least one hypothesis with use of the pieces of feedback information accumulated in the FB information storage section 14A.

### (Specific Examples of Hypothesis Graphs)

FIG. 4 is a drawing illustrating example hypothesis graphs H1 to H3 which the hypothesis display section 12A causes the display device 3 to display. As described above, a hypothesis graph is a graph in which a plurality of elements, which make up a hypothesis, and a combination thereof are expressed with use of nodes and at least one edge.

For example, the hypothesis graph H1 illustrated in FIG. 4 is obtained by connecting nodes N1 to N3 and a node N10 with use of edges shown by arrows. The nodes N1 to N3 correspond to respective evidences 1 to 3, and the node N10 corresponds to the consequence that leakage of information occurred. Note that the evidences 1 to 3 are each based on observation information stored in the observation information storage section 112A, and the consequence is derived on the basis of the evidences 1 to 3 and inference knowledge which is stored in the inference knowledge storage section 113A.

It can be read from the hypothesis graph H1 that a hypothesis indicated by the hypothesis graph H1 is a hypothesis in which the consequence that leakage of information occurred has been derived from three elements, i.e., the evidences 1 to 3. In each of the nodes, a sentence indicating a content of an element which corresponds to the each of the nodes is displayed. This allows a user to recognize contents of the elements.

The hypothesis graph H2 is a graph obtained by adding a node N4 to the hypothesis graph H1. The node N4 corresponds to a hypothesis A for deriving the consequence N10. The hypothesis graph H3 is a graph obtained by adding a node N5, instead of the node N4, to the hypothesis graph H1. Similarly to the node N4, the node N5 is a hypothesis for deriving the consequence N10, but the node N5 corresponds to not the hypothesis A but a hypothesis B. Note that the hypotheses A and B are each derived from the observation information and the inference knowledge, and each compensate for an evidence which is not observed.

As has been described, the information processing device 1A according to the second example embodiment employs a configuration such that the hypothesis display section 12A causes the display device 3 to display hypothesis graphs in each of which a plurality of elements and a combination thereof are expressed with use of nodes and edges, as described above. The acceptance section 13A accepts, from a user, a feedback on at least one selected from the group consisting of the nodes and the edges in each of the hypothesis graphs.

In abductive inference, a hypothesis expressed by logical formulae is generated by a computation based on the logical formulae. By not causing the generated logical formulae to be displayed but causing a hypothesis graph as described above to be displayed, it is possible even for a user who has poor knowledge about the logical formulae to easily understand a content of the hypothesis. Then, it is possible for the user to intuitively provide a feedback on at least one selected from the group consisting of nodes and at least one edge in the hypothesis graph.

Thus, the information processing device 1A brings about, in addition to the effect brought about by the information processing device 1 according to the first example embodiment, the effect that it is possible to cause a user to easily recognize a content of a hypothesis and also possible to cause the user to easily provide a feedback on at least one of elements making up the hypothesis. Note that a combination of nodes and at least one edge in a hypothesis graph can also be expressed as a graphical feature of the hypothesis graph. The graphical feature is as described in the first example embodiment, and therefore will not be described.

### (Flow of Hypothesis Generation Method)

A flow of a hypothesis generation method according to the second example embodiment is described with reference to FIG. 5. FIG. 5 is a flowchart illustrating a flow of the hypothesis generation method which the information processing device 1A carries out.

In S11, the acceptance section 13A accepts input of observation information. The observation information may be inputted, for example, by a user via the input device 2. The acceptance section 13A then stores, in the observation information storage section 112A of the hypothesis generation section 11A, the observation information thus inputted.

In S12, the hypothesis generation section 11A carries out abductive inference with use of the observation information inputted in S11 to generate at least one hypothesis. More specifically, the inference engine 111A of the hypothesis generation section 11A carries out the abductive inference with use of the observation information stored in the observation information storage section 112A and inference knowledge stored in the inference knowledge storage section 113A to generate the at least one hypothesis. The inference engine 111A basically generates a plurality of hypotheses. However, depending on a constraint condition (described later), the inference engine 111A may generate a single hypothesis.

In S13, the hypothesis display section 12A causes the display device 3 to display a plurality of elements making up each of a plurality of hypotheses that have been generated in S12. More specifically, the hypothesis display section 12A generates hypothesis graphs in each of which the plurality of elements, which make up each of the plurality of hypotheses that have been generated in S12, and a combination thereof are expressed with use of nodes and at least one edge, and causes the display device 3 to display the hypothesis graphs that the hypothesis display section 12A has generated.

In S14, the hypothesis display section 12A determines whether to end generation of a hypothesis. In a case where it is determined to end the generation (YES in S14), the flow illustrated in FIG. 5 ends. In a case where it is determined not to end the generation (NO in S14), the flow proceeds to S15.

As a condition under which the determination in S14 is made, any of the following conditions, for example, may be applied.

(1) In S12, a single hypothesis has been generated.

(2) The at least one hypothesis generated in S12 does not include an element on which the user can provide a feedback.

(3) The hypotheses displayed in S13 include a hypothesis which is convincing to the user.

In a case where the hypothesis display section 12A makes the determination under the condition (2), the hypothesis display section 12A only needs to determine, with reference to the FB information storage section 14A, whether or not the at least one hypothesis generated in S12 includes an element on which a feedback has not been provided. In a case where the at least one hypothesis includes an element on which a feedback has not been provided, a result of the determination in S14 is NO, because the at least one hypothesis includes an element on which the user can provide a feedback. On the contrary, in a case where feedbacks have been already provided on all of the elements, a result of the determination in S14 is YES, because the at least one hypothesis does not include an element on which the user can provide a feedback.

In a case where the determination is made under the condition (3), the user may be caused to input, for example, via the input device 2, whether or not the hypotheses displayed in S13 include a hypothesis which is convincing to the user. In this case, the hypothesis generation section 11A only needs to determine to end generation of a hypothesis (YES in S14), on the condition that the acceptance section 13A has accepted an input indicating that the hypotheses include a convincing hypothesis.

In S15, the acceptance section 13A accepts, from the user, a feedback on at least one of the plurality of elements that have been displayed by the process in S13. Since the hypothesis graphs are displayed in S13 as described above, the acceptance section 13A accepts, in S15, a feedback on at least one selected from the group consisting of the nodes and the at least one edge in each of the hypothesis graphs. Note that, in S15, the acceptance section 13A may accept a feedback on only one of the hypothesis graphs that have been displayed, or may accept a feedback on each of the hypothesis graphs.

In a case where, in the process in S15, there is a feedback that the acceptance section 13A has previously accepted, the acceptance section 13A may accept an operation to cancel the feedback. For example, the acceptance section 13A may cause the display device 3 to display pieces of feedback information stored in the FB information storage section 14A, and cause the user to select, from the pieces of feedback information, a piece of feedback information which the user desires to cancel. In this case, an operation to select the piece of feedback information which the user desires to cancel is the operation to cancel the feedback.

In S16, the acceptance section 13A determines whether the feedback which the acceptance section 13A has accepted in S15 is cancellation of a previous feedback or the other feedback. In a case where the acceptance section 13A determines that the feedback is cancellation of a previous feedback (YES in S16), the flow proceeds to S17. On the contrary, in a case where the acceptance section 13A determines that the feedback is the other feedback (NO in S16), the flow proceeds to S18.

In S17, the acceptance section 13A deletes, from the FB information storage section 14A, feedback information of the feedback which has become a subject of cancellation. On the contrary, in S18, the acceptance section 13A generates feedback information indicating a content of the feedback which the acceptance section 13A has accepted in S15, and records the feedback information in the FB information storage section 14A. After end of S17 or S18, the flow proceeds to a process in S19.

In S19, the inference engine 111A of the hypothesis generation section 11A updates a constraint condition in the abductive inference on the basis of the feedback information stored in the FB information storage section 14A. Thereafter, the flow returns to the process in S12. In S12 which is carried out after S19, the inference engine 111A applies the constraint condition updated in S19, and regenerates at least one hypothesis.

Then, as has been already described, (i) hypotheses are displayed (S13), (ii) a feedback is accepted again unless a result of determination in S14 is YES (S15), (iii) feedback information is deleted or recorded (S17/S18), and (iv) the constraint condition is updated (S19). These processes are repeated until a result of determination in S14 becomes YES.

Note that in a case where a large number of hypotheses are generated in S12 and then displayed in S13, it is conceivable that a task of checking all of the hypotheses is a burden for the user. Therefore, it is preferable to set an upper limit to the number of hypotheses generated in S12. Note that the upper limit may be a fixed value or may be varied depending on each inference.

In S12 which is carried out after S19, the inference engine 111A may output, as a new hypothesis, a candidate hypothesis (hypothesis which has not been ultimately outputted) generated by previous abductive inference. For example, it is assumed that the inference engine 111A generated three candidate hypotheses by the process in the first S12 and outputted two selected from the candidate hypotheses and then a negative feedback was provided on an element of one of the two. In this case, in a case where the candidate hypothesis which was generated in the first S12 but was not outputted does not include the element on which the negative feedback was provided, the inference engine 111A may output this candidate hypothesis as a new hypothesis in S12 which is carried out after S19. Such a process is also included in the scope of regeneration of a hypothesis.

### (Example of Generation of Hypotheses and Hypothesis Graphs)

A specific example of generation of hypotheses and hypothesis graphs along the flow illustrated in FIG. 5 is described with reference to FIG. 4. Here, it is assumed that the hypothesis generation section 11A generates two hypotheses in S12 illustrated in FIG. 5. It is also assumed that the hypothesis display section 12A then generates the hypothesis graphs H1 and H2 illustrated in FIG. 4 as hypothesis graphs corresponding to the respective hypotheses, and causes the display device 3 to display the hypothesis graphs H1 and H2.

In this case, a user only needs to select a target of feedback, from among the nodes N1 to N3 and N10 which make up the hypothesis graph H1, the nodes N1 to N4 and N10 which make up the hypothesis graph H2, and the edges which connect these nodes. The user only needs to then input a content of a feedback on a node, an edge, or a combination of nodes and edges which the user has selected.

For example, in a case where the user does not consider that a content of the hypothesis A indicated by the node N4 is appropriate as a cause of the consequence (leakage of information) indicated by the node N10, the user only needs to select the node N4 via the input device 2 and input a feedback indicating that the node N4 is inappropriate.

In a case where the acceptance section 13A accepts the feedback in S15, the acceptance section 13A generates feedback information corresponding to the feedback, and records the feedback information in the FB information storage section 14A in S18. In this case, the feedback information to be recorded is information indicating that the node N4 is inappropriate.

In S19, the inference engine 111A of the hypothesis generation section 11A updates a constraint condition on the basis of the feedback information indicating that the node N4 is inappropriate. For example, the inference engine 111A may newly add the constraint condition that the node N4 is not included. As a result, in regeneration of at least one hypothesis in S12 which is carried out after S19, a hypothesis including the node N4 is not generated. Thus, in subsequent S13, the hypothesis graph H1 which does not include the node N4 is displayed again, and also a hypothesis graph which has been newly generated and which does not include the node N4 (for example, H3 illustrated in FIG. 4) is displayed.

### (Accumulation of Feedback Information)

As has been described above, the information processing device 1A according to the second example embodiment employs a configuration such that the acceptance section 13A records pieces of feedback information on respective feedbacks that the acceptance section 13A has accepted. The information processing device 1A also employs a configuration such that the hypothesis generation section 11A applies a constraint condition which corresponds to each of the pieces of feedback information that have been recorded, and regenerates at least one hypothesis.

Therefore, the information processing device 1A brings about, in addition to the effect brought about by the information processing device 1 according to the first example embodiment, the effect that it is possible to generate a hypothesis in which feedbacks provided a plurality of times by a user are reflected.

### (Additional Remark)

As described below, in the abductive inference carried out by the information processing device 1A, in a case where the number of graphical features which are handled is finite, a hypothesis which has the same graphical features as a correct hypothesis is ultimately generated by repetition of (i) feedback based on the correct hypothesis and (ii) re-inference. Thus, according to the information processing device 1A, it is possible to generate a correct hypothesis by repetition of right feedback based on the correct hypothesis (for example, providing a feedback indicating that an element which is included in the correct hypothesis is appropriate and an element which is not included in the correct hypothesis is inappropriate).

As has been described, the hypothesis generation section 11A generates a plurality of hypotheses that differ from each other in graphical feature. For example, it is assumed that the hypothesis generation section 11A generated two hypotheses H₀ and H₁. In this case, it can be said that the hypothesis H₀ includes a graphical feature which is not included in H₁ or H₁ includes a graphical feature which is not included in H₀. And, it is undetermined whether these graphical features are appropriate or not.

Thus, it is only necessary to repeat, a number (finite number) of times that is equal to the number of these graphical features of which appropriateness or inappropriateness is undermined, a process of accepting a feedback on a graphical feature of which appropriateness or inappropriateness is undermined and carrying out re-inference on the basis of the feedback. This causes a hypothesis which has the same graphical features as a correct hypothesis to be generated.

Further, in the abductive inference which the information processing device 1A carries out, in a case where embeddabilities of all hypothesis graphs are defined as sets of features which are handled, there is a natural feedback strategy by which a correct hypothesis is definitely reached. That is, in a case where a user who knows a correct hypothesis repeats right feedback based on the correct hypothesis on each of graphical features included in the hypothesis graphs, it is possible for the information processing device 1A to definitely generate the correct hypothesis. This is theoretically guaranteed as described below. Note that, as a premise of this, it is assumed that the kinds of constants and predicates which are handled are finite and that the hypothesis graphs are finite graphs.

For example, the correct hypothesis is defined as Hⱼ, and the number of nodes that make up Hⱼ is defined as n. In this case, on a hypothesis in which the number of nodes is (n+1), a feedback indicating that the hypothesis is inappropriate is provided. Thus, repetition of feedback and regeneration of at least one hypothesis causes a hypothesis in which the number of nodes is (n+1) or more not to be generated. That is, regeneration of at least one hypothesis is carried out within the range of the number of nodes, which is finite, i.e., n or less.

Further, since the number of subgraphs (graphical features) which can be embedded in Hⱼ is finite with the exception of isomorphic subgraphs, a feedback indicating appropriateness is provided a finite number of times. Further, as described above, since the number of features of which appropriateness or inappropriateness is undetermined is also finite, a feedback indicating inappropriateness is also provided a finite number of times. Therefore, by repeating feedback on appropriateness or inappropriateness a finite number of times, a correct hypothesis is definitely reached.

### (Cancellation of Feedback)

As described above, the information processing device 1A according to the second example embodiment employs a configuration such that the acceptance section 13A accepts cancellation of a feedback which the acceptance section 13A has already accepted. The acceptance section 13A deletes, from the FB information storage section 14A, feedback information on the feedback which has become a subject of cancellation.

Thus, the hypothesis generation section 11A applies a constraint condition which corresponds to, among pieces of feedback information that have been recorded, feedback information other than the feedback information corresponding to the feedback of which cancellation has been accepted, and regenerates at least one hypothesis.

Therefore, the information processing device 1A brings about, in addition to the effect brought about by the information processing device 1 according to the first example embodiment, the effect that, in a case where a user notices that a previous feedback is an error, it is possible to prevent the error from affecting subsequent generation of at least one hypothesis. A user generally does not know a correct hypothesis, and therefore it is possible that the user makes an erroneous feedback. Then, since it is possible that the user notices, from a content of a hypothesis displayed after the feedback, the possibility that the previous feedback is an error, the above configuration which allows for cancellation of a feedback is useful.

A method of causing a user to select a feedback which is to be cancelled is not limited in particular. For example, the acceptance section 13A may cause the display device 3 to display an option for canceling a feedback (for example, a key for canceling the most recent feedback), and may cancel the feedback when the option is selected. Alternatively, for example, the acceptance section 13A may cause the display device 3 to display pieces of feedback information recorded in the FB information storage section 14A, and may cause the user to select feedback information which is to be cancelled, from among the pieces of feedback information that have been displayed.

### (Example of Screen for Accepting Feedback)

As has been described, the hypothesis display section 12A causes the display device 3 to display a plurality of elements making up each of a plurality of hypotheses that have been generated. In so doing, the hypothesis display section 12A may cause the display device 3 to display hypothesis graphs in each of which the plurality of elements, which make up the each of the plurality of hypotheses, and a combination thereof are expressed with use of nodes and at least one edge. In this case, a display screen including the hypothesis graphs is a UI (user interface) screen for accepting a feedback from a user.

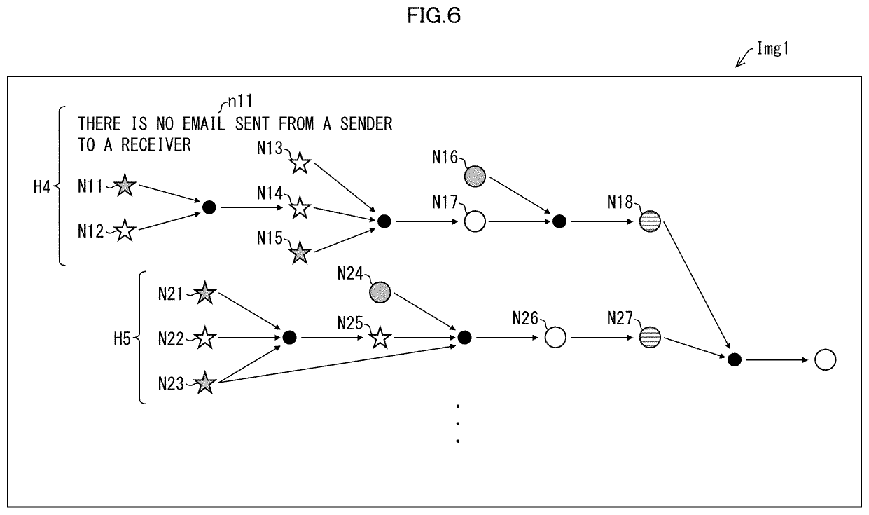

FIG. 6 is a drawing illustrating an example of the UI screen for accepting a feedback from a user. On a screen Img1 illustrated in FIG. 6, a plurality of hypotheses that have been generated by the hypothesis generation section 11A are displayed with use of respective hypothesis graphs each having a tree structure. Specifically, on the screen Img1, displayed are (i) a hypothesis graph H4 in which nodes N11 to N18 and edges that connect the nodes N11 to N18 are elements making up a hypothesis and (ii) a hypothesis graph H5 in which nodes N21 to N27 and edges that connect the nodes N21 to N27 are elements making up a hypothesis. Note that three or more hypothesis graphs connected in a tree structure may be displayed on the UI screen.

The nodes included in the hypothesis graphs H4 and H5 include nodes which differ in shape and color (pattern). Specifically, the nodes N11 to N15, N21 to N23, and N25 each have a star shape, and the other nodes each have a circular shape. The nodes N11, N15, N16, and others are colored gray, the nodes N12 to N14 and others are colored white, and the nodes N18 and N27 are patterned with horizontal stripes.

By changing appearances of nodes depending on the nodes in this manner, it is possible to cause a user to easily recognize what node each of the nodes is. For example, a node which corresponds to observation information may be caused to have a star shape, a node which corresponds to a hypothesis may be caused to have a circular shape, a node which has been verified may be colored white, a note which has not been verified may be colored gray, and a node which indicates a consequence may be patterned with horizontal stripes.

Moreover, on the screen Img1, a sentence n11 that reads “there is no email sent from a sender to a receiver” is displayed in association with the node N11. This sentence n11 indicates a content of the node N11. In this manner, a sentence which indicates a content of each of nodes that make up each of hypothesis graphs may be caused to be displayed. Note that such a sentence may be caused to be continuously displayed or may be caused to be displayed in response to a given operation conducted by a user.

In a case where the hypothesis display section 12A causes the hypothesis graphs H4 and H5 to be displayed, the acceptance section 13A may accept a selection operation conducted by a user with respect to at least one selected from the group consisting of the nodes N11 to N18 and the edges that connect these nodes, which make up the hypothesis graph H4, and the nodes N21 to N27 and the edges that connect these nodes, which make up the hypothesis graph H5. A content of the selection operation is not limited in particular. For example, in a case where the input device 2 is a mouse, an operation to point a node or an edge with use of the mouse and then click the node or the edge may be a selection operation with respect to the node or the edge.

Furthermore, in response to a selection operation conducted with respect to a node or an edge, the hypothesis display section 12A may cause the display device 3 to display a selection screen for causing a user to select a content of a feedback on the node or the edge.

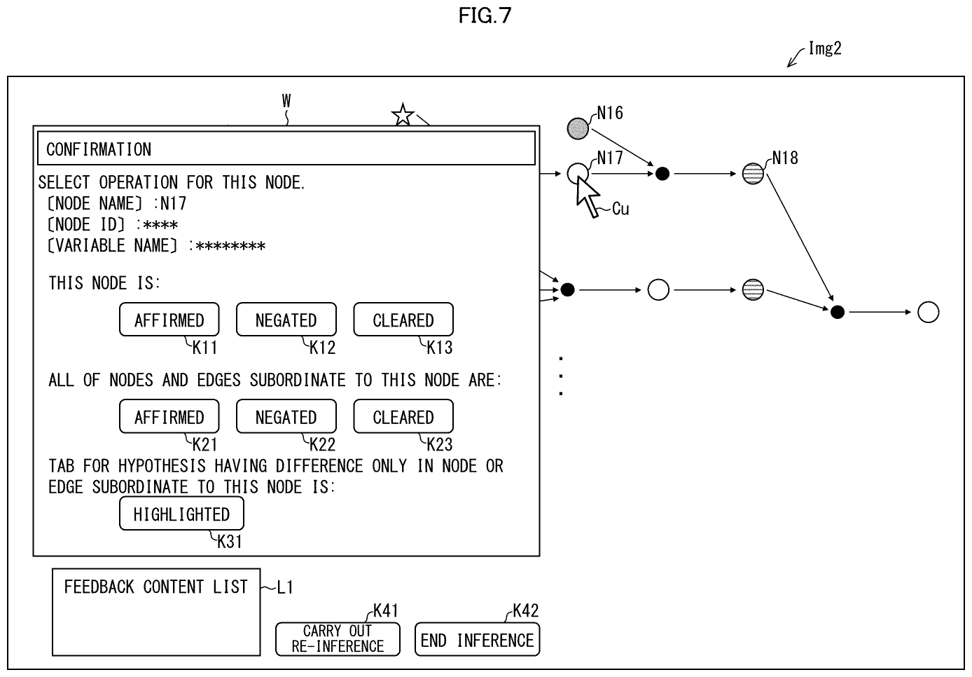

FIG. 7 is a drawing illustrating an example of the selection screen for causing a user to select a content of a feedback. As a premise under which Img2 illustrated in FIG. 7 is displayed, it is assumed that the node N17, included in the hypothesis graph H4 illustrated in FIG. 6, was selected by a cursor Cu and then a window W was displayed in response to this selection operation.

The window W is an example of the selection screen for causing a user to select a content of a feedback. In the window W, a node name, a node ID, and a variable name of the selected node are displayed, and also keys K11 to K13 and K21 to K23 each for selecting a content of a feedback on the selected node are displayed.

In the example illustrated in FIG. 7, it is assumed that it is possible to accept a plurality of feedbacks and carry out re-inference in which the plurality of feedbacks are reflected. Thus, in addition to the window W, displayed is a feedback content list L1 for displaying a list of contents of feedbacks provided by a user. A key K41 for causing re-inference to be carried out and a key K42 for causing re-inference to be ended are also displayed. Note that the feedback content list L1 and the keys K41 and K42 may be caused to be displayed also while the window W is not displayed.

By using the window W, it is possible for a user to provide a feedback on a hypothesis with the simple operation of selecting a key which corresponds to a desired content of the feedback. For example, in a case where a user determines that a content of the node N17 is appropriate, the user only needs to conduct an operation to select the key K11. The acceptance section 13A accepts this operation as a feedback indicating that the node N17 is appropriate, and causes the node N17 to be displayed as an affirmative node in the feedback content list L1. In a case where the key K41 for causing re-inference to be carried out is subsequently selected, the acceptance section 13A generates feedback information indicating that the node N17 is appropriate, and records the feedback information in the FB information storage section 14A. The hypothesis generation section 11A then applies the constraint condition that the node N17 is included, and regenerates at least one hypothesis. Note that in a case where another node is displayed in the feedback content list L1 when the key K41 is selected, a feedback on the another node is also recorded in the FB information storage section 14A. Thus, at least one hypothesis is regenerated also under a constraint condition concerning the another node.

On the contrary, in a case where the user determines that the content of the node N17 is inappropriate, the user only needs to conduct an operation to select the key K12. The acceptance section 13A accepts this operation as a feedback indicating that the node N17 is inappropriate, and causes the node N17 to be displayed as a negative node in the feedback content list L1. In a case where the key K41 for causing re-inference to be carried out is subsequently selected, feedback information indicating that the node N17 is inappropriate is recorded in the FB information storage section 14A, and then at least one hypothesis is regenerated under the constraint condition that the node N17 is not included.

In a case where the user desires to delete a feedback displayed in the feedback content list L1, the user only needs to select a target node from the feedback content list L1 or the hypothesis graphs and then select the key K13. This makes it possible to delete the node from the feedback content list L1.

In a case where the user determines that a method of deriving the node N17, i.e., a combination of nodes and edges subordinate to the node N17 is appropriate, the user only needs to conduct an operation to select the key K21. The acceptance section 13A accepts this operation as a feedback indicating that the combination of the nodes and the edges subordinate to the node N17 is appropriate, and causes information indicating that the node N17 and the combination of the nodes and the edges subordinate to the node N17 have been affirmed to be displayed in the feedback content list L1. Thereafter, in a case where the key K41 for causing re-inference to be carried out is selected, at least one hypothesis is regenerated under the constraint condition that the combination of the nodes and the edges subordinate to the node N17 is included.

In a case where the user determines that the method of deriving the node N17, i.e., the combination of the nodes and the edges subordinate to the node N17 is inappropriate, the user only needs to conduct an operation to select the key K22.

The acceptance section 13A accepts this operation as a feedback indicating that the nodes and the edges subordinate to the node N17 is inappropriate, and causes information indicating that the combination of the nodes and the edges subordinate to the node N17 have been negated to be displayed in the feedback content list L1. Thereafter, in a case where the key K41 for causing re-inference to be carried out is selected, at least one hypothesis is regenerated under the constraint condition that the combination of the nodes and the edges subordinate to the node N17 is not included.

In a case where the user desires to delete the node N17 and the nodes and the edges subordinate to the node N17 from the feedback content list L1, the user only needs to conduct an operation to select the key K23. This makes it possible to delete the node N17 and the nodes and the edges subordinate to the node N17 from the feedback content list L1. As in these examples, a feedback can be provided collectively on all of nodes and edges subordinate to a selected node. This makes it possible to greatly narrow down the range of next abductive inference by a single feedback.

A key K31 for highlighting a tab for a hypothesis which has a difference only in node or edge subordinate to a selected node is also displayed in the window W. In a case where the acceptance section 13A accepts an operation to select the key K31, the hypothesis display section 12A searches for a hypothesis which has a difference only in node or edge subordinate to a selected node. In a case where the hypothesis display section 12A detects such a hypothesis, the hypothesis display section 12A causes a hypothesis graph of the hypothesis to be displayed in a highlighted manner.

As has been described, in the information processing device 1A according to the second example embodiment, the acceptance section 13A may accept at least one of (i) a feedback indicating that an element which makes up a hypothesis is appropriate and (ii) a feedback indicating that an element which makes up the hypothesis is inappropriate. In this case, the hypothesis generation section 11A applies at least one of (1) the constraint condition that the element on which the feedback indicating that the element is appropriate has been provided is included and (2) the constraint condition that the element on which the feedback indicating that the element is inappropriate has been provided is not included, and regenerates at least one hypothesis.

Thus, the information processing device 1A according to the second example embodiment brings about, in addition to the effect brought about by the information processing device 1 according to the first example embodiment, the effect that it is possible to cause a user to provide a feedback in accordance with a criterion which is easy for the user to understand and which causes the user to easily make a determination, i.e., whether an element is appropriate or not.

### (Feedback on Quality of Entire Hypothesis)

In the information processing device 1A according to the second example embodiment, the acceptance section 13A may accept a feedback on the quality of an entire hypothesis, and may record the hypothesis and information indicating a content of the feedback in association with each other.

According to the above configuration, in addition to the effect brought about by the information processing device 1 according to the first example embodiment, brought about is the effect that it is possible to acquire data on what kind of hypothesis is convincing to a user or is unlikely to be convincing to the user. The data recorded in this manner can also be used, for example, in evaluation of the quality of a hypothesis or analysis of a hypothesis.

A method of accepting a feedback on the quality of a hypothesis is not limited in particular. For example, the hypothesis display section 12A may cause the display device 3 to display options concerning the quality of a hypothesis, and the acceptance section 13A may accept a content of an option selected by a user, as a feedback on the quality of the hypothesis. Alternatively, for example, the acceptance section 13A may accept, as a feedback on the quality of a hypothesis, a sentence which has been inputted by a user and which indicates the quality of the hypothesis.

### (Other Feedback)

As has been described, a feedback only needs to be on at least one of elements which make up each of hypotheses and which the hypothesis display section 12A has caused to be displayed. Moreover, a content of the feedback only needs to make it possible to determine a constraint condition for regenerating at least one hypothesis.

For example, the acceptance section 13A may accept a feedback indicating that the number of nodes making up each of hypothesis graphs which the hypothesis display section 12A has caused to be displayed is appropriate or not or is excessively large or excessively small. In a case where the acceptance section 13A accepts such a feedback, the hypothesis generation section 11A may add a constraint condition concerning the number of nodes on the basis of the feedback and regenerate at least one hypothesis.

### [Variation]

Each of the above-described processes may be shared by a plurality of information processing devices. Namely, at least one other information processing device may be caused to carry out a part of the processes carried out by the information processing device 1 or 1A. In other words, in a case where at least one processor is caused to carry out each of the above-described processes, the at least one processor may be included in a single information processing device 1 or 1A, or may be included in different information processing devices.

For example, another information processing device may be caused to carry out generation and regeneration of at least one hypothesis, among the processes carried out by the information processing device 1 or 1A. In this case, the information processing device 1 or 1A only needs to carry out the process of causing hypotheses generated by the another information processing device to be displayed and the process of accepting a feedback.

### [Software Implementation Example]

A part or all of the functions of each of the information processing devices 1 and 1A may be realized by hardware such as an integrated circuit (IC chip) or may be alternatively realized by software.

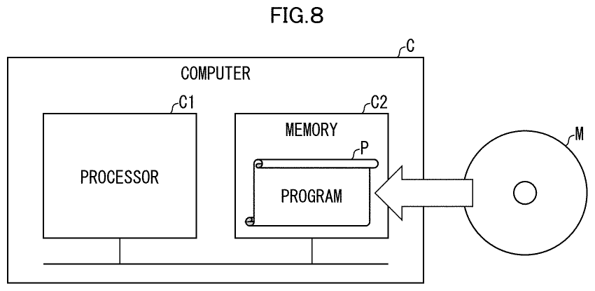

In the latter case, the information processing devices 1 and 1A are each realized by, for example, a computer that executes instructions of a program that is software realizing the functions. FIG. 8 illustrates an example of such a computer (hereinafter, referred to as “computer C”). The computer C includes at least one processor C1 and at least one memory C2. In the memory C2, a program P for causing the computer C to operate as the information processing device 1 or 1A is recorded. In the computer C, the functions of the information processing device 1 or 1A are realized by the processor C1 reading the program P from the memory C2 and executing the program P. That is, the program P causes the computer C to function as the hypothesis generation section 11 or 11A, the hypothesis display section 12 or 12A, and the acceptance section 13 or 13A.

The processor C1 may be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination thereof. The memory C2 may be, for example, a flash memory, a hard disk drive (HDD), a solid state drive (SSD), or a combination thereof.

Note that the computer C may further include a random access memory (RAM) in which the program P is loaded when executed and/or in which various kinds of data are temporarily stored. The computer C may further include a communication interface for transmitting and receiving data to and from another device. The computer C may further include an input/output interface for connecting the computer C to an input/output apparatus such as a keyboard, a mouse, a display, and a printer.

The program P can also be recorded in a non-transitory tangible recording medium M from which the computer C can read the program P. Such a recording medium M may be, for example, a tape, a disk, a card, a semiconductor memory, a programmable logic circuit, or the like. The computer C can acquire the program P via such a recording medium M. The program P can also be transmitted via a transmission medium. Such a transmission medium may be, for example, a communication network, a broadcast wave, or the like. The computer C can acquire the program P via such a transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

The whole or part of the example embodiments disclosed above can be described as follows. Note, however, that the present invention is not limited to the following example aspects.

An information processing device according to a first aspect employs a configuration such that the information processing device includes: a hypothesis generation means for generating, by abductive inference, a plurality of hypotheses that differ from each other; a hypothesis display means for causing a display device to display a plurality of elements making up each of the plurality of hypotheses that have been generated; and an acceptance means for accepting, from a user, a feedback on at least one of the plurality of elements that have been displayed, the hypothesis generation means applying a constraint condition which varies depending on the feedback, and regenerating at least one hypothesis. According to this configuration, it is possible to generate a hypothesis which is convincing to a user.

The information processing device according to a second aspect employs, in addition to the configuration of the first aspect, a configuration such that: the acceptance means accepts at least one of (i) a feedback indicating that at least one of the plurality of elements is appropriate and (ii) a feedback indicating that at least one of the plurality of elements is inappropriate; and the hypothesis generation means applies at least one of (1) the constraint condition that the at least one of the plurality of elements, on which the feedback indicating that the at least one of the plurality of elements is appropriate has been provided, is included and (2) the constraint condition that the at least one of the plurality of elements, on which the feedback indicating that the at least one of the plurality of elements is inappropriate has been provided, is not included, and regenerates the at least one hypothesis. According to this configuration, it is possible to cause a user to provide a feedback in accordance with a criterion which is easy for the user to understand and which causes the user to easily make a determination, i.e., whether an element is appropriate or not.

The information processing device according to a third aspect employs, in addition to the configuration of the first or second aspect, a configuration such that: the acceptance means accepts feedbacks, and records pieces of feedback information which indicate respective contents of the feedbacks; and the hypothesis generation means applies the constraint condition which corresponds to each of the pieces of feedback information that have been recorded, and regenerates the at least one hypothesis. According to this configuration, it is possible to generate a hypothesis in which feedbacks provided a plurality of times by a user are reflected.

The information processing device according to a fourth aspect employs, in addition to the configuration of the third aspect, a configuration such that: the acceptance means accepts cancellation of at least one of the feedbacks which the acceptance means has already accepted; and the hypothesis generation means applies the constraint condition which corresponds to, among the pieces of feedback information that have been recorded, each of pieces of feedback information other than a piece of feedback information corresponding to the at least one of the feedbacks of which the cancellation has been accepted, and regenerates the at least one hypothesis. According to this configuration, in a case where a user notices that a previous feedback is an error, it is possible to prevent the error from affecting subsequent generation of a hypothesis.

The information processing device according to a fifth aspect employs, in addition to the configuration of any one of the first through fourth aspects, a configuration such that: the hypothesis display means causes the display device to display hypothesis graphs in each of which the plurality of elements, which make up the each of the plurality of hypotheses, and a combination of the plurality of elements are expressed with use of nodes and at least one edge; and the acceptance means accepts a feedback on at least one selected from the group consisting of the nodes and the at least one edge in each of the hypothesis graphs. According to this configuration, it is possible to cause a user to easily recognize a content of a hypothesis and also possible to cause the user to easily provide a feedback on an element making up the hypothesis.

An information processing device according to a sixth aspect employs, in addition to the configuration of any one of the first through fifth aspects, a configuration such that the acceptance means accepts a feedback on an overall quality of at least one of the plurality of hypotheses, and records the at least one of the plurality of hypotheses and a piece of information which indicates a content of the feedback in association with each other. According to this configuration, it is possible to acquire data on what kind of hypothesis is convincing to a user or is unlikely to be convincing to the user.

A hypothesis generation method according to a seventh aspect employs a configuration such that the hypothesis generation method includes: (a) generating, by abductive inference, a plurality of hypotheses that differ from each other; (b) causing a display device to display a plurality of elements making up each of the plurality of hypotheses that have been generated; (c) accepting, from a user, a feedback on at least one of the plurality of elements that have been displayed; and (d) applying a constraint condition which varies depending on the feedback, and regenerating at least one hypothesis, the steps (a) through (d) being carried out by at least one processor. According to this configuration, it is possible to generate a hypothesis which is convincing to a user.

A program according to an eighth aspect employs a configuration such that the program is for causing a computer to function as an information processing device, the program causing the computer to function as: a hypothesis generation means for generating, by abductive inference, a plurality of hypotheses that differ from each other; a hypothesis display means for causing a display device to display a plurality of elements making up each of the plurality of hypotheses that have been generated; and an acceptance means for accepting, from a user, a feedback on at least one of the plurality of elements that have been displayed, the hypothesis generation means applying a constraint condition which varies depending on the feedback, and regenerating at least one hypothesis. According to this configuration, it is possible to generate a hypothesis which is convincing to a user.

A recording medium according to a ninth aspect employs a configuration such that the recording medium is a computer-readable recording medium in which a program for causing a computer to function as an information processing device is recorded, the program causing the computer to function as: a hypothesis generation means for generating, by abductive inference, a plurality of hypotheses that differ from each other; a hypothesis display means for causing a display device to display a plurality of elements making up each of the plurality of hypotheses that have been generated; and an acceptance means for accepting, from a user, a feedback on at least one of the plurality of elements that have been displayed, the hypothesis generation means applying a constraint condition which varies depending on the feedback, and regenerating at least one hypothesis. According to this configuration, it is possible to generate a hypothesis which is convincing to a user.

### [Additional Remark 3]

The whole or part of the example embodiments disclosed above can also be expressed as follows. An information processing device includes at least one processor, the at least one processor carries out: a process of generating, by abductive inference, a plurality of hypotheses that differ from each other; a process of causing a display device to display a plurality of elements making up each of the plurality of hypotheses that have been generated; a process of accepting, from a user, a feedback on at least one of the plurality of elements that have been displayed; and applying a constraint condition which varies depending on the feedback, and regenerating at least one hypothesis.

Note that this information processing device may further include a memory, and, in this memory, a program may be stored which is for causing the at least one processor to carry out the process of generating a plurality of hypotheses, the process of causing a display device to display a plurality of elements, the process of accepting a feedback, the process of regenerating at least one hypothesis. Alternatively, this program may be recorded in a computer-readable non-transitory tangible recording medium.

### REFERENCE SIGNS LIST

1, 1A Information processing device
11, 11A Hypothesis generating section (hypothesis generation means)
12, 12A Hypothesis display section (hypothesis display means)
13, 13A Acceptance section (acceptance means)

What is claimed is:

1. An information processing device comprising at least one processor, the at least one processor carrying out:
a hypothesis generation process of generating, by abductive inference, a plurality of hypotheses that differ from each other;
a hypothesis display process of causing a display device to display a plurality of elements making up each of the plurality of hypotheses that have been generated; and
an acceptance process of accepting, from a user, a feedback on at least one of the plurality of elements that have been displayed,
in the hypothesis generation process, the at least one processor applying a constraint condition which varies depending on the feedback, and regenerating at least one hypothesis.

2. The information processing device as set forth in claim 1, wherein:
in the acceptance process, the at least one processor accepts at least one of (i) a feedback indicating that at least one of the plurality of elements is appropriate and (ii) a feedback indicating that at least one of the plurality of elements is inappropriate; and
in the hypothesis generation process, the at least one processor applies at least one of (1) the constraint condition that the at least one of the plurality of elements, on which the feedback indicating that the at least one of the plurality of elements is appropriate has been provided, is included and (2) the constraint condition that the at least one of the plurality of elements, on which the feedback indicating that the at least one of the plurality of elements is inappropriate has been provided, is not included, and regenerates the at least one hypothesis.

3. The information processing device as set forth in claim 1, wherein:
in the acceptance process, the at least one processor accepts feedbacks, and records pieces of feedback information which indicate respective contents of the feedbacks; and
in the hypothesis generation process, the at least one processor applies the constraint condition which corresponds to each of the pieces of feedback information that have been recorded, and regenerates the at least one hypothesis.

4. The information processing device as set forth in claim 3, wherein:
in the acceptance process, the at least one processor accepts cancellation of at least one of the feedbacks which the at least one processor has already accepted; and
in the hypothesis generation process, the at least one processor applies the constraint condition which corresponds to, among the pieces of feedback information that have been recorded, each of pieces of feedback information other than a piece of feedback information corresponding to the at least one of the feedbacks of which the cancellation has been accepted, and regenerates the at least one hypothesis.

5. The information processing device as set forth in claim 1, wherein:
in the hypothesis display process, the at least one processor causes the display device to display hypothesis graphs in each of which the plurality of elements, which make up the each of the plurality of hypotheses, and a combination of the plurality of elements are expressed with use of nodes and at least one edge; and
in the acceptance process, the at least one processor accepts a feedback on at least one selected from the group consisting of the nodes and the at least one edge in each of the hypothesis graphs.

6. The information processing device as set forth in claim 1, wherein in the acceptance process, the at least one processor accepts a feedback on an overall quality of at least one of the plurality of hypotheses, and records the at least one of the plurality of hypotheses and a piece of information which indicates a content of the feedback in association with each other.

7. A hypothesis generation method comprising:
(a) generating, by abductive inference, a plurality of hypotheses that differ from each other;
(b) causing a display device to display a plurality of elements making up each of the plurality of hypotheses that have been generated;
(c) accepting, from a user, a feedback on at least one of the plurality of elements that have been displayed; and
(d) applying a constraint condition which varies depending on the feedback, and regenerating at least one hypothesis,
the steps (a) through (d) being carried out by at least one processor.

8. (canceled)

9. A non-transitory computer-readable recording medium in which a program for causing a computer to function as an information processing device is recorded, the program causing the computer to carry out:
a hypothesis generation process of generating, by abductive inference, a plurality of hypotheses that differ from each other;
a hypothesis display process of causing a display device to display a plurality of elements making up each of the plurality of hypotheses that have been generated; and
an acceptance process of accepting, from a user, a feedback on at least one of the plurality of elements that have been displayed,
in the hypothesis generation process, the computer applying a constraint condition which varies depending on the feedback, and regenerating at least one hypothesis.
